(19) United States
(12) Patent Application Publication
(10) Pub. No.: US 2010/0325035 A1
(43) Pub. Date: Dec. 23, 2010

(54) FRAUD/RISK BUREAU

(76) Inventors: Nancy Hilgers, Danville, CA (US); Brad Nightengale, Redwood Shores, CA (US); Mark Nelsen, Oakland, CA (US); Ann Ewing, San Carlos, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/816,785

(22) Filed: Jun. 16, 2010

Related U.S. Application Data
(60) Provisional application No. 61/218,358, filed on Jun. 18, 2009.

(51) Int. Cl. G06Q 40/00; G06Q 99/00

(52) U.S. Cl. 705/38; 705/325

(57) ABSTRACT

Systems and methods for generating fraud/risk report for consumers are disclosed. A server computer in a fraud/risk system receives a request from a client computer of a user for a fraud/risk report associated with a consumer. The server computer queries a database that stores pre-filtered data provided from third party sources, and data (filtered or not filtered) from a payment processing network that processes payment card transactions. The pre-filtered data are associated with reported fraudulent activities. The server computer then generates a fraud/risk report and provides that report to the client computer of the user. The report includes the pre-filtered data that were associated with the consumer. The fraud/risk report may also be customized based on the request of the user or based on pre-determined criteria stored in the server computer.

### CROSS-REFERENCES TO RELATED APPLICATIONS

This application claims the benefit of U.S. Provisional Patent Application No. 61/218,358, filed Jun. 18, 2009, entitled “Fraud/Risk Bureau”, disclosure of which is incorporated herein by reference for all purposes.

### BACKGROUND

Today, credit bureaus provide credit reports to businesses to help them make decisions on whether to conduct business with prospective consumers. A credit bureau can provide a credit profile that contains a consumer's name, address, employer, accounts with various financial institutions, credit limits, account balances, payment history, possible negative information based on recorded judgments, collection activities, etc. This information is used to generate a credit score that describes the risk associated with a consumer. A business can use this credit score to determine the creditworthiness of the consumer.

While credit reports are useful, this credit report information may not be up-to-date and may not provide the most accurate characterization of a particular consumer at a given time.

Furthermore, there are some limitations regarding the use of credit bureau information. For example, a fraudster may try and open a mobile phone account with a service provider using someone else's identity. During the application process, the service provider realizes that the fraudster is providing stolen identity information and is engaging in potentially fraudulent activity. Currently, there is no way to report this type of the fraudulent activity so that it can be used to prevent future attempted transactions using the stolen identity information.

Embodiments of the invention address these and other problems, individually and collectively.

### BRIEF SUMMARY

Embodiments of the invention disclosed herein include systems and methods for using data from a payment processing network and pre-filtered data from third party data sources to generate fraud and/or risk reports for consumers. In embodiments of the invention, a fraud/risk report can include one which indicates that the level of fraud, and consequently the risk of fraudulent activity.

Embodiments of the invention are directed to systems and methods for generating fraud/risk reports. In one embodiment, a server computer can receive a request from a client computer for a fraud/risk report associated with a consumer. The server computer can query a database that stores pre-filtered data provided from third party data sources, and also data from a payment processing network. The server computer then generates a fraud/risk report and may provides that report to the client computer. The report may also be based on a pre-determined set of criteria.

Another embodiment of the invention is directed to a method comprising submitting a request to a server computer using a client computer, wherein the request includes an identifier for a consumer; and receiving a report from the server computer, wherein the report includes data derived from pre-filtered data from a plurality of data sources and data from a payment processing network.

Other embodiments of the invention are directed to computer readable media and systems for implementing the above-described methods and other methods.

These and other embodiments of the invention are described in further detail below.

### BRIEF DESCRIPTION OF THE DRAWINGS

FIG. 1 shows a system according to an embodiment of the invention.

FIG. 2 shows a database and the types of data that are stored in the database, according to an embodiment of the invention.

FIG. 3 shows an example of the types of data in a risk report according to an embodiment of the invention.

FIG. 4 shows an example of the types of data in a fraud report according to an embodiment of the invention.

FIG. 5 shows another example of the types of data in a risk report according to an embodiment of the invention.

FIG. 6 shows a flowchart that illustrates the steps involved in receiving a request from a user and generating a fraud/risk report, according to an embodiment of the invention.

FIG. 7 shows a flowchart that illustrates the step involved in receiving data from entities that provide data to the fraud/risk system, according to an embodiment the invention.

FIG. 8 shows a system according to an embodiment of the invention.

### DETAILED DESCRIPTION

Embodiments of the invention include systems and methods for aggregating previously determined fraudulent and/or inaccurate consumer data from various third party data sources and consumer data from a payment processing network, and then providing risk assessments. More specifically, embodiments of the invention can relate to a fraud prevention mechanism where users may obtain accurate and current data relating to fraudulent activity.

Illustratively, an issuer may decide to provide a credit offer to a consumer. The personal information provided by the consumer can be compared against pre-filtered fraudulent and/or incorrect information to determine if the consumer or the consumer's identity is associated with potential fraudulent activity. This system may be used, on a global scale, by a wide variety of entities such as retailers, issuers, small businesses, lenders (e.g., credit, mortgage, auto and personal) and risk solution providers.

In some embodiments, a central server computer in the system gathers pre-filtered data associated with fraudulent activity from third party data sources such as credit bureaus, communication service providers such as mobile phone network operators, merchants, etc. In addition, the server computer may obtain transaction related account level data from a payment processing network that is configured to process payment card transactions. The data from the payment processing network may be pre-filtered or may not be pre-filtered.

In embodiments of the invention, the “pre-filtered data” can be derived from activities that were previously identified by entities (e.g., third party entities) as being fraudulent or potentially fraudulent. The pre-filtered data may be provided to the server computer by the entities on a periodic basis (e.g., monthly, weekly, or daily) or at the request of the server computer. Further, the pre-filtered data may be combined with unfiltered or pre-filtered account level transaction data from a payment processing network that is configured to process payment card transactions to provide an appropriate report that can indicate the risk of fraud that is associated with a particular consumer or consumer's identity. The account level transaction data that may be associated with a particular consumer or consumer's identity and is more current than the pre-filtered data that is provided from third party sources. When the pre-filtered data and the account level transaction data are combined, very accurate and complete fraud reports can be provided to any suitable entity that may request such information.

In an exemplary embodiment, an auto lender can receive a credit application for an auto loan from a person. Using a client computer, the auto lender can then submit a request to a central server computer in the system to check the credit application information against the data in the system. Once the request is received, the server computer can query one or more databases containing data which includes the pre-filtered data and the transaction data (which may or may not be pre-filtered). It can determine if there is a match between the information in the credit application and in the pre-filtered data and/or the transaction data.

After the query is conducted, a fraud risk report is provided to the auto lender. The report may provide an assessment of the risk of fraudulent activity. In this example, the person that submitted the credit application to the auto lender may be a fraudster that previously attempted to fraudulently use the same stolen identity for another purpose with a second entity (e.g., a telecommunications network operator such as Verizon™), but was prevented from proceeding because the second entity realized that the information that was provided by the fraudster was not authentic. After the attempted fraudulent transaction at the second entity, the second entity could have previously reported the fraudulent activity to the central server computer.

When the auto lender submits the request to the central server computer, a report can be provided to the auto lender. It can indicate that the identity of the consumer in the loan application was previously used in a fraudulent or potentially fraudulent attempt to open another account with the second entity. Further, the report may also indicate that a payment card with consumer's identity was used in a manner that is uncharacteristic of the authentic consumer's behavioral profile. Upon receiving this information, the auto lender can use greater care when processing the application (e.g., by asking for additional documentation proving that the person asking for the loan is the authentic consumer). If the auto lender realizes that the person submitting the loan application is an unauthorized consumer (i.e., a fraudster), the loan can be denied and information regarding the fraudulent attempt can be provided back to the server computer in the system.

Embodiments of the invention have a number of advantages. For example, data that is not traditionally captured or aggregated can be aggregated and combined with transaction data to provide more comprehensive and accurate fraud reports. For instance, a typical credit bureau does not record unsuccessful attempts at identity theft, and does not store transaction data associated with payment cards. Thus, the data provided by traditional credit bureaus is not as accurate or current as the information provided by embodiments of the invention.

Other specific examples of embodiments of the invention are described in further detail below.

### I. Systems

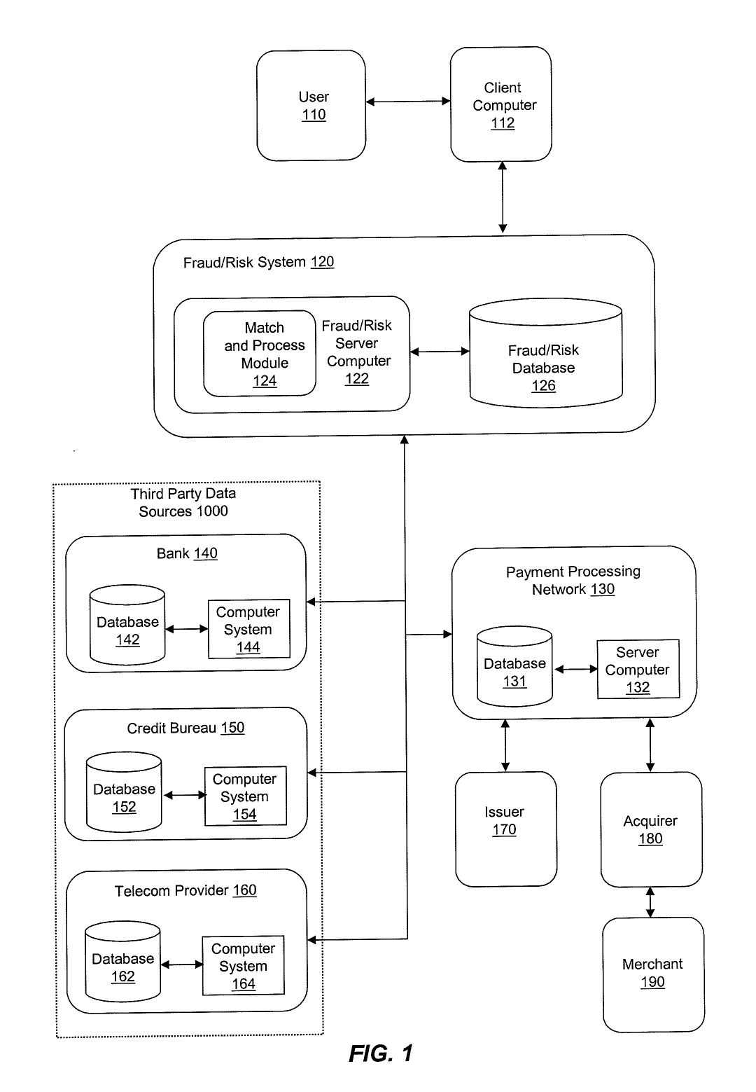

FIG. 1 shows a diagram a system according to an embodiment of the invention. FIG. 1 shows a user 110 that operates a client computer 112. The client computer 112 may be coupled to a fraud/risk system 120, which comprises a fraud/risk server computer 122, which may include a match and process module 124. The fraud/risk server computer 122 may also be coupled to a fraud/risk database 126 which may reside in the fraud/risk system 120. A number of third party data sources 1000 including a bank 140, credit bureau 150, and a telecom provider 160, and a payment processing network 130 may be operatively coupled to the fraud/risk system 120. An issuer 170, acquirer 180, and a merchant 190 may be operatively coupled to the payment processing network 130. Further details regarding the foregoing entities are provided below.

As noted above, the user 110 can communicate with the fraud/risk system 120 via the client computer 112. In some embodiments, the user 110 can be a person or entity that is interested in receiving information from the fraud/risk system 120. The client computer 112 may be in the form of a personal computer system, phone or other device that is capable of communication and data processing.

The fraud/risk system 120, also sometimes referred to as the fraud/risk bureau, refers to a system having access to one or more third party data sources (e.g., banks, credit bureaus, telecom companies, etc.) and payment processing networks and uses pre-filtered data associated with reported fraudulent activities to provide risk assessment solutions to clients of the system.

The fraud/risk server computer 122 in the fraud/risk system 120 can communicate with a fraud/risk database 126, which is also in the fraud/risk system 120. The fraud/risk server computer 122 can include and run a match and process module 124 which can include a computer readable medium (not shown) comprising code that is executable by a processor (not shown) in the fraud/risk server computer 122. It queries one or more databases containing pre-filtered data, and obtains transaction data, and can generate and provides reports for users

As used herein, a “server computer: is typically a powerful computer or cluster of computers. For example, the server computer can be a large mainframe, a minicomputer cluster, or a group of servers functioning as a unit. In one example, the server computer may be a database server coupled to a Web server.

The payment processing network 130 communicates with acquirers and issuers to facilitate payment transactions conducted using portable consumer devices such as payment cards. Such communications may include the use of authorization request messages, which may comprise transaction information such as account numbers, transaction amounts, authentication data such as card verification values, and merchant verification values. Other communication messages may include settlement messages for clearing and setting payment card transactions.

The payment processing network 130 may have or operate a server computer (e.g., server computer 132) and may include a database 131. The payment processing network 130 may include data processing subsystems, networks, and operations used to support and deliver authorization services, exception file services, and clearing and settlement services. An exemplary payment processing network 130 may include VisaNet™. Networks that include VisaNet™ are able to process credit card transactions, debit card transactions, and other types of commercial transactions. VisaNet™, in particular, includes an integrated payments system (integrated payments system) that processes authorization requests and a Base II system which performs clearing and settlement services. The payment processing network 130 may use any suitable wired or wireless network, including the Internet.

The issuer 170 can refers to any suitable entity that may open and maintain an account associated with a portable consumer device (not shown) for a consumer, which may be an individual or a business entity. Some examples of issuers may be a bank, a business entity such as a retail store, or a governmental entity. In many cases, the issuer 170 may also issue portable consumer devices associated with the account to a consumer.

The acquirer 180 can be any suitable entity that has an account with merchant 190. In some embodiments, the issuer 170 may also be the acquirer 180.

The merchant 190 can refers to any suitable entity or entities that can conduct a transaction with consumers. The merchant 190 may use any suitable method for conducting a transaction. For example, the merchant 190 may conduct transactions using the Internet or in person. Examples of merchants include a department store, a gas station, a drug store, a grocery store, etc.

A number of third party data sources 1000 may also be in communication with the fraud/risk system 120. For purposes of illustration, a bank 140, credit bureau 150, and telecom provider 160 are shown. It is understood that any suitable number and types of third party data sources may be used in embodiments of the invention.

Bank 140 can refer to an entity or a financial institution that provides banking services and/or financing services to individuals and businesses. Bank 140 has a database 142 and a computer system 144 which are operatively coupled to each other.

Credit bureau 150 can refer to an entity that generates credit profiles for individuals. Each credit profile contains a list of loans that an individual associated with a credit profiles holds and payment history for each of those loans. Credit bureau 150 also uses the information in the credit profile on an individual to determine the creditworthiness of individuals. Credit bureau 150 has a database 152 and a computer system 154 which are operatively coupled to each other.

Telecom provider 160 can refer to an entity that provides voice and/or data communication services to individuals and businesses. Telecom provider 160 has a database 162 and a computer system 164 which are operatively coupled to each other.

### II. Methods

Referring to FIG. 1, fraud/risk system 120 communicates with the payment processing network 130 and third party data sources such as the bank 140, credit bureau 150, telecom 160, etc. and uses various types of pre-filtered data associated with fraudulent activities that are generated by these entities to provide fraud/risk analysis solutions to clients and users of the system such as user 110.

In some embodiments, fraud/risk system 120 directly accesses one or more databases that are managed by the payment processing network 130 and any one of the third party data sources that contain the pre-filtered data. More specifically, fraud/risk system 120 accesses databases 131, 142, 152, and 162 that contain the pre-filtered data. In some other embodiments, fraud/risk system 120 may receive the pre-filtered data from the payment processing network 130 and the third party data sources and aggregate such data in fraud/risk database 126.

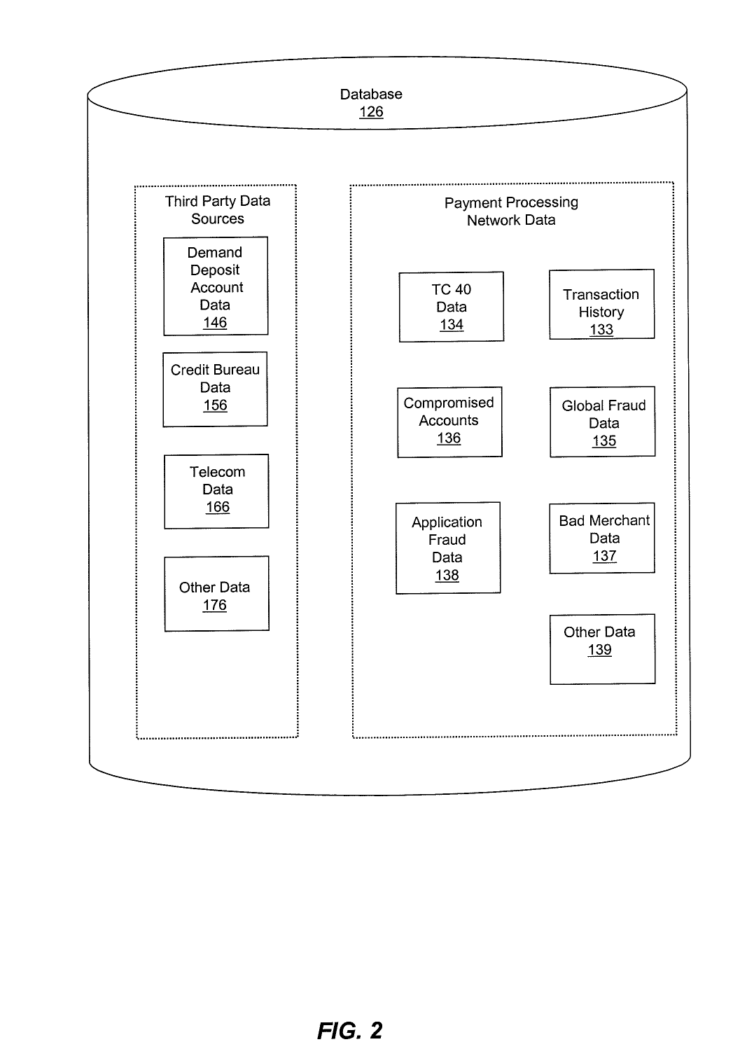

FIG. 2 illustrates the types of pre-filtered data that fraud/risk system 120 may receive from the payment processing network 130 and third party data sources. FIG. 2 illustrates the embodiment where such data are aggregated by the fraud/risk system 120 and stored in the fraud/risk database 126. In other embodiments, the fraud/risk system 120 may access the databases of payment processing network and third party data sources where such data may be stored.

As shown in FIG. 2, the types of data that may be provided by the payment processing network 130 may include transaction history data 133, TC 40 data 134, global fraud data 135, compromised account data 136, bad merchant data 137, and application fraud data 138. FIG. 2 also shows the data that each of the third party data sources provide to the fraud/risk system 120. These data are the pre-filtered data that the third party data sources gather during the course of business, and results from fraudulent activities of fraudsters that either resulted in financial loss or a successful and/or unsuccessful attempt to defraud that entity. FIG. 2 show examples of pre-filtered data received from the third party data sources shown in FIG. 1. These pre-filtered data include demand deposit account data 146, credit bureau data 156, and telecom data 166.

Transaction history data 133 can include authorization data for all accounts that run through the payment processing network 130. Authorization data can indicate whether a transaction was approved or declined. During a typical payment transaction, a consumer presents a portable consumer device to merchant 190 to purchase goods or services. Merchant 190 generates an authorization request using a Point of Sale (POS) payment terminal and sends that authorization request to the acquirer 180. Acquirer 180 will then send the authorization request to the payment processing network 130. Payment processing network 130 then forwards the authorization request to the issuer 170. The issuer 170 then generates an authorization response, which indicates whether the transaction is approved or declined. The authorization response is sent to the acquirer 180 through the payment processing network 130. The acquirer 180 then notifies the merchant 190 about the result. The payment processing network 130 keeps track of the transaction history data 133 that can include the record of authorization data for the transactions. In some embodiments, transaction history data 133 may be filtered by the payment processing network 130 to indicate the transactions that were deemed to be fraudulent and/or unauthorized.

TC 40 data 134, also referred to as transaction code 40, are fraudulent transactions that are reported by issuers such as issuer 170 to the payment processing network 130. In some embodiments, issuer 170 classifies a transaction as fraudulent when an accountholder notifies the issuer 170 of a transaction that the accountholder claims not to have participated in, or otherwise authorized.

Global fraud data 135 can include refer to fraud data that includes the TC 40 data 134 and the details on such transactions. The details include, for example, location of the transaction, the merchant involved with that transaction, the account number associated with the fraudulent transaction, etc.

Compromised account data 136 can include a list of accounts that were issued by an issuer (e.g., issuer 170) and were involved in a data breach. For example, when consumers submit their account information to various businesses, those businesses may experience a security breach where some of their consumer's information including their account information is compromised. Payment processing network 130 keeps tracks of the accounts that were compromised.

Bad merchant data 137 can include a list of merchant accounts that are terminated by an acquirer that opened those accounts for merchants. These merchant accounts may have been terminated for various reasons, in some cases, due to fraudulent activity of the merchants.

Application fraud data 137 can include data such as name, address, social security number, etc. that were provided to an issuer (e.g., issuer 170) by a person to open an account, but it was determined that the information that the person provided is not accurate or that does not belong to that person.

In some embodiments, the payment processing network 130 receives some of the types of data shown in FIG. 2 from the issuers and acquirers (e.g., issuer 170 and acquirer 180) and/or aggregates such data as a result of communication with the issuers and acquirers. For example, the payment processing network 130 aggregates the transaction history data 133 when receiving authorization requests and responses from acquirers and issuers respectively, and receives the compromised account data 136 from issuer 170 based on an agreement.

It will be understood by those skilled in the art that other types of data, in addition to what is shown in FIG. 2, may be received/accessed by the fraud/risk system 120. Therefore, fraud/risk system 120 may receive additional types of data from the payment processing network 130 which is shown as other data 139 in FIG. 2. Furthermore, additional data may be received from other third party data sources, which is shown as other data 176.

In some embodiments, the data in the fraud/risk database 126 are received in real time. This means that any of the entities that provide data to the fraud/risk system 120 can provide new data as soon as such data are deemed to be relevant to the type of data provided to the fraud/risk system 120. In other embodiments, the data in the fraud/risk database 126 are received on a frequent pre-scheduled basis. In some embodiments, the data may be received on a daily or weekly or any other schedule but preferably before one month from the date of the last update. In the embodiments, where the fraud/risk server computer 122 accesses the databases of the payment processing network or any one of the third party data sources, the fraud/risk server computer 122 can also access such databases on a frequent pre-scheduled basis. In some embodiments, fraud/risk system 120 may receive data from the payment processing network 130 and the third party data sources and access their databases as necessary to keep the data in the fraud/risk database 126 up-to-date.

Referring back to FIG. 1, fraud/risk system 120 can advantageously use the types of data that it can receive and/or access through the payment processing network 130 and third party data sources to create fraud reports for individuals. The fraud reports may then be supplied to the users of the fraud/risk system 120 to safeguard against fraudulent activities.

In some embodiments, fraud/risk system 120 includes types of information in the fraud reports that may be used to determine whether someone is a target of identity fraud. In one example, suppose that user 110 is a lender who receives an application for a loan and submits a request to the fraud/risk system 120 to receive a fraud report that will be used to assess any risk of fraud. The user 110 submits some or all of the information, such as name, address, social security, etc., provided in the loan application, to fraud/risk system 120. The request from the user 110 is submitted via a client computer (e.g., client computer 112) to the fraud/risk server computer 122 in fraud/risk system 120. The match and process module 124 directs the fraud/risk server computer 122 to query the fraud/risk database 126 for possible matches between any of the information that were submitted by the user 110 and the data in the fraud/risk database 126. If there are matches between the information that the user 110 provided and the pre-filtered data in the fraud/risk database 126, then fraud/risk server computer 122 includes those data in a fraud report that is going to generate and provide to the client computer 112.

If the name and information of the person in the loan application were previously reported to the fraud/risk system 120 by the payment processing network 130 or any one of the third party data sources, then fraud/risk server computer 122 would include that information in the fraud report. From the vantage point of the user 110, when a fraud report is received from the fraud/risk system 120 that indicates some or all of the information in the loan application were previously used in a case of attempted identity fraud, then the user 110 may decide to ask for additional documentation from the loan applicant to safeguard against fraud.

In another example, combination of some of the types of data available to the fraud/risk system 120 may advantageously be used to determine the possibility of fraud. For example, transaction history data 133 and bad merchant data 137 can be used to determine if a person performed a transaction with a merchant that was determined to be implicated in fraudulent activity. Alternatively or additionally, from the compromised account data 136 and the pre-filtered data from any one of the third party data sources, it can be determined if a person's financial information was compromised and later an attempt was made to fraudulently open an account under that person's name. User 110 can then assess the likelihood of a fraudulent activity when provided with a fraud report.

In some embodiments, the fraud/risk system 120 may provide some guidelines to the third party data sources on how to filter the data that will eventually be used by the fraud/risk system 120. More specifically, third party data sources gather data during their course of business that would help the fraud/risk system 120 to use such data, in addition to other data provided by other entities to determine the chance of fraud. In one embodiment, third party data sources may save a list of names of people who did not complete the application process when they were asked to prove their identity or that it was determined that their name was provided by fraudsters to open an account with that entity. For example, telecom 160 may save the information that were provided to open an account for wireless phone, but either the application was not pursued when the telecom 160 asked for more information, or for whatever reason it was suspected or determined that the information in an application were incorrect/fraudulent.

Fraud/risk system 120 may then use the pre-filtered data from the third party data sources to help other businesses safe guard against identity fraud. This feature of the fraud/risk system is particularity advantageous since credit bureaus do not record the attempt of identity theft. Currently, credit bureaus place a fraud alert on credit reports when requested by the consumer or a creditor on behalf of the consumer. However, if the consumer is not aware that a fraudster is continually attempting to steal his identity, there is no measure to let the person or the business know about such attempts. Creditors also do not place a fraud alert when the consumer's data was used to commit fraud for accounts that do not yet exist (i.e. application fraud). Knowing that fraudsters may have targeted someone's identity helps the person and businesses to prevent the identity fraud, which is costly for both sides. When third party data sources notify the fraud/risk system 120 about attempts of identity theft, the information is placed in a fraud report which makes it much harder for the fraudster to steal that person's identity in the subsequent attempts.

In some embodiments, fraud/risk system 120 includes types of information in the fraud profiles that may be used to determine the probability that someone is attempting to defraud a business entity. More specifically, in such cases, the issue is not identity fraud. Rather, someone may be using his own identity to try and defraud a business entity. In such cases, fraud/risk system 120 may generate a risk report or a fraud report that would help a business assess the risk of extending credit to or engaging in a business relationship with a consumer.

In one example, a consumer may try to open a line of credit with a lender (in this example, user 110 in FIG. 1 is the lender). The lender may submit a request via client computer 112 to fraud/risk system 120 for a risk report that will help the lender assess the risk associated with that consumer. Fraud/risk system 120 will use the pre-filtered data that it receives from the payment processing network 130 and/or third party data sources to generate a fraud/risk report for that consumer. More specifically, match and process module 124 directs the fraud/risk server computer 122 to query fraud/risk database 126 for transaction history 133, TC 40 data 134, demand deposit account data 146, credit bureau data 156. In this example, this mix of data types helps the fraud/risk system 120 to generate a risk report that helps the lender determine if the consumer may have the intention of receiving the line of credit, spending the money and then refuse to pay the balance owed to the lender.

Transaction history data 133 provides, for example, information regarding whether the consumer has recently started using his payment cards with a higher frequency than normal. TC 40 data 134 indicates whether or not there were any transactions in the recent past that the consumer claims not to have authorized and were potentially fraudulent. This helps the lender to determine if there is any potentially fraudulent activity relating to the use of the consumer's payment cards by others. Demand deposit account data 146 can include information including whether the consumer has overdrawn his checking account or has bounced checks. Credit bureau data 156 includes information including whether there are any reported collection activities on behalf of other lenders for recover balances owed by that consumer. The credit bureau data 156 includes information including the last reported balances on all revolving accounts and installments for that consumer.

In some embodiments, the fraud/risk server computer 122 may provide the data to the client computer 112. In some other embodiments, an application program running on the fraud/risk server computer 122 may use these data to calculate a fraud/risk score associated with the consumer. It can be appreciated that a report generated using the types of data that are accessible by the fraud/risk system 120 will be more informative to a user of the system than a credit profile provided by a credit bureau. Although some of the information in a credit profile may also be included in a report provided by the fraud/risk system 120, as in the above example, the credit report by itself cannot be used as reliably as a report that is provided by the fraud/risk system 120. In particular, the data in credit profiles are being updated on a monthly basis. Therefore, the information in a credit profile may not depict accurate and up to date financial information of a person. Moreover, the fraud/risk system 120 advantageously has access to data from payment processing network 130 which are not used by a credit bureau to generate credit profiles.

In some embodiments, the fraud/risk system 120 may help businesses and/or issuers of credit and debit cards determine whether they should authorize a transaction. For example, an issuer may not authorize a payment transaction for an expensive item if the account associated with that transaction is in the list of compromised accounts 136 or TC 40 data 134.

In some embodiments, the fraud/risk system 120 may help the users monitor certain aspects of consumer's financial activity. For example, a user may want to monitor a list of their consumers by one or more identifiers (e.g., name, account number, social security, etc.) and receive notification if a consumer's financial status changes, or becomes a target of identity fraud, engages in a suspected fraudulent activity, etc. The notification may in the form of an alert that would be triggered in cases where new reports are received by the fraud/risk system 120 about consumers. A particular consumer may not be associated with any fraudulent and/or risky activity at the time that a client of fraud/risk system 120 requests for a fraud report or risk report. However, the user may want to be notified in case of any future reports about that consumer. Therefore, fraud/risk system 120 advantageously helps users minimize their risk by receiving up-to-date notification about their consumers.

In one example, a user may request for a fraud report and a risk report for a consumer. At that time, there may not be any data associated with that consumer that would suggest the user should not engage in a business relationship with that consumer. However, the fraud/risk system 120 may set a trigger that would generate an alert when there are any new data for that consumer. The triggers may be customized based on the particular needs and concerns of the users. For example, a creditor may receive an alert if a consumer becomes a target of identity fraud. The creditor may then take the necessary steps to protect that consumer's account from fraudulent activity.

In some other embodiments, the fraud/risk system 120 may allow the users to request for customized reports that help them in strategic decision-making. For example, a cable company may request for a customized report that includes reported data associated with delinquent payments (if any) of a consumer from other cable companies. The cable company uses such a report to determine if the consumer has been paying his bills when he had an account with other business entities of similar type. In this particular example, the cable company may not be concerned about other risks or whether the consumer has a good credit history or not. If it can be determined that the consumer has been paying his bills to other cable companies, then that would make him qualify.

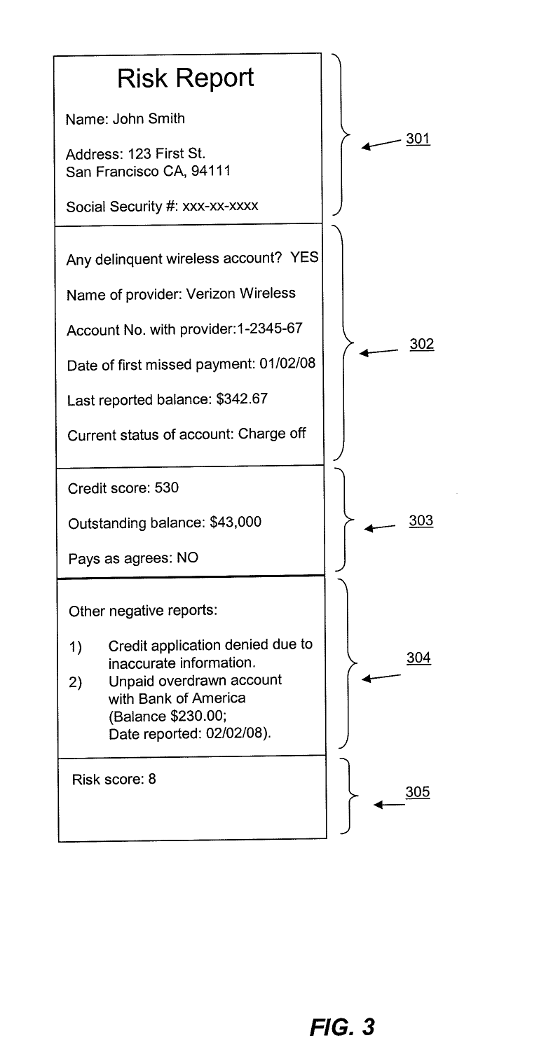

FIG. 3 illustrates an example of a customized risk report. This risk report may have been generated based on a request from a telecom company. In this example, Mr. John Smith tries to open a wireless phone account with a telecom company, and as a result, the telecom company submits a request to fraud/risk system 120 for a customized report that would indicate the risk associated with John Smith. As part of the request, the telecom company may indicate the particular types of information that it requires, and the risk report will be generated accordingly.

As shown in FIG. 3, the risk report for John Smith includes five sections. Section 301 includes some of the personal information of John Smith. Section 302 includes specific data related to previous wireless phone account(s) that Mr. Smith has had with other service providers and negative information (if any) associated with those previous accounts. In this example, section 302 indicates that there has been a reported delinquent account with Verizon Wireless™ that was reported to the fraud/risk system 120. Section 303 includes some credit information that is received from a credit bureau. This section shows that Mr. Smith does not have a good credit. Section 304 indicates that there are other negative reports associated with Mr. Smith. This section indicates that Mr. Smith has provided inaccurate information in a credit application that was denied, and that he has an unpaid overdrawn account with a bank. Section 305 includes a risk score on a scale of 1-10. This risk score may be calculated based on the information that is provided in the customized risk report and other information accessible by the fraud/risk system 120 that may not be reflected in the customized risk report. In this example, the telecom company uses this customized risk report to determine if Mr. Smith qualifies for a wireless phone account.

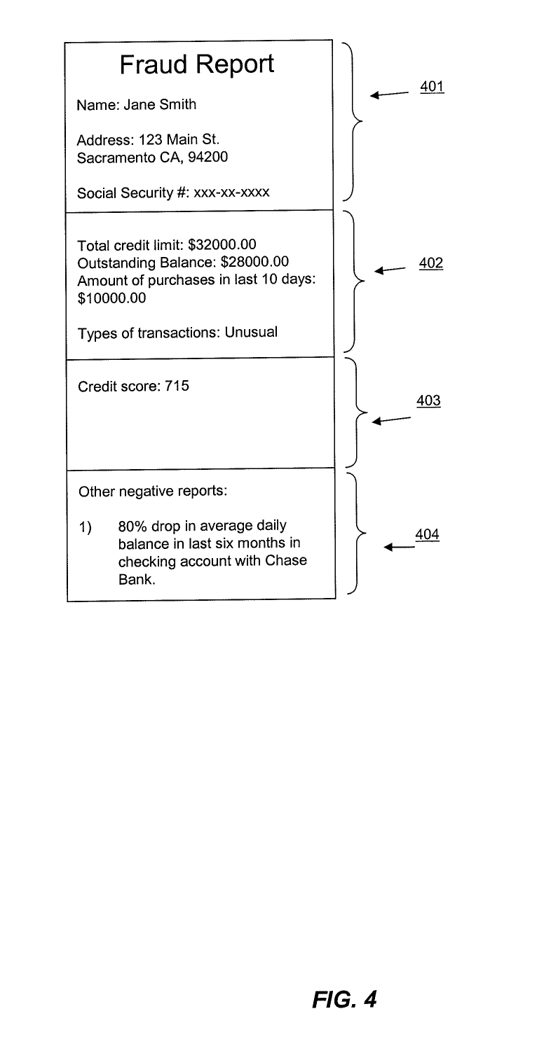

FIG. 4 illustrates an example of a customized fraud report. This customized fraud report may have been requested by a creditor that is considering a line of credit to Ms. Jane Smith. As in the example above, the creditor may request for specific types of data to be included in the fraud report. In this case, the creditor is concerned with a type of fraud where people apply for credit, spend the money and do not pay the outstanding balance. This may happen when consumers are faced with financial difficulty and attempt to “cash out” their credit before their financial situation results in closure of their credit accounts.

In this example, the fraud report includes Ms. Smith's personal information in section 401. Section 402 includes the amount of credit, outstanding balance, amount of transaction in the last 10 days, and the types of transactions. The amount of credit may be provided by a credit bureau. The outstanding balance may be provided by a credit bureau and the payment processing network 130. The amount of transaction in the last 10 days may be provided by the payment processing network 130 which may use transaction history 133 to provide this amount. Type of transaction may be also provided by the payment processing network 130 which in this example is determined to be unusual given other transactions previously conducted by Ms. Smith.

Section 403 includes the credit score for Ms. Smith. Section 404 includes a report from a bank that Ms. Smith has an account with. This bank has reported that the daily average balance of Ms. Smith has dropped significantly. From these data, the lender in this example, may determine that although Ms. Smith's credit score is good, there are other reasons that may indicate Ms. Smith is not creditworthy despite her current credit score. Further, the velocity of recent transactions and the amount of recent purchases, in addition to the report from her bank may indicate an attempt of fraud as described above. Even though, Ms. Smith's credit score indicates that she is credit worthy, other information regarding her account activities indicate that there is a chance that Ms. Smith is engaging in a fraudulent activity.

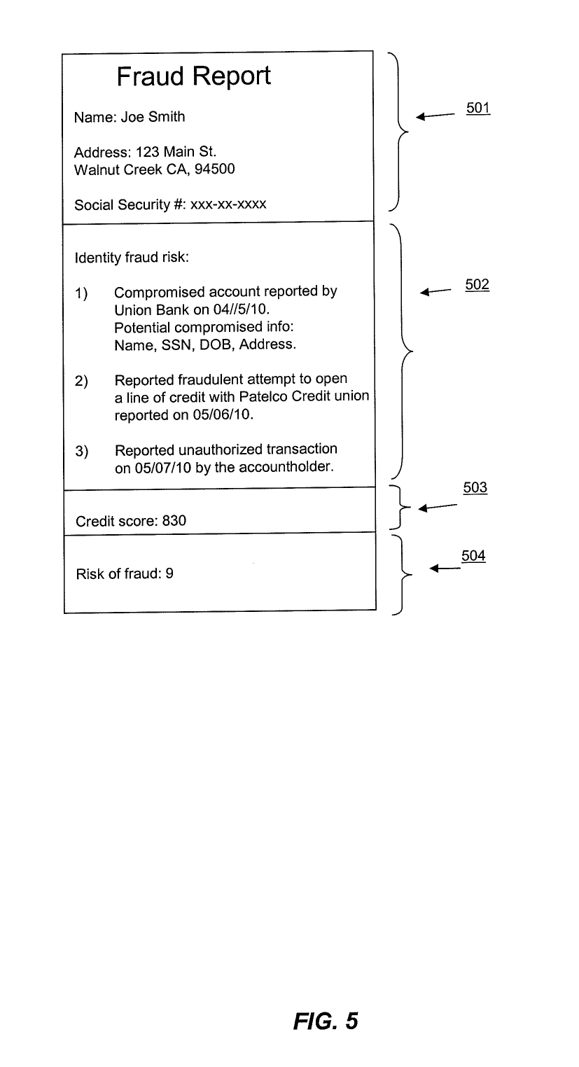

FIG. 5 illustrates another type of fraud report which indicates whether someone is a target of identity fraud. This fraud report includes Mr. Joe Smith's personal information in section 501. Section 502 includes the types of reports that indicate that Joe Smith may be a target of identity fraud. This section indicates that Joe Smith's account information was compromised, there was a reported fraudulent attempt to open an account under his name, and that he has reported unauthorized charges to one of his accounts. These data may be provided by the third party data sources 1000 and the payment processing network 130. From these data fraud/risk system 120 calculates that the chance of Joe Smith being a target of identity fraud is 9 on a 1-10 scale. This fraud report helps a creditor to safe guard against fraudulent activity by potentially asking for more documents that would prove the identity of the applicant.

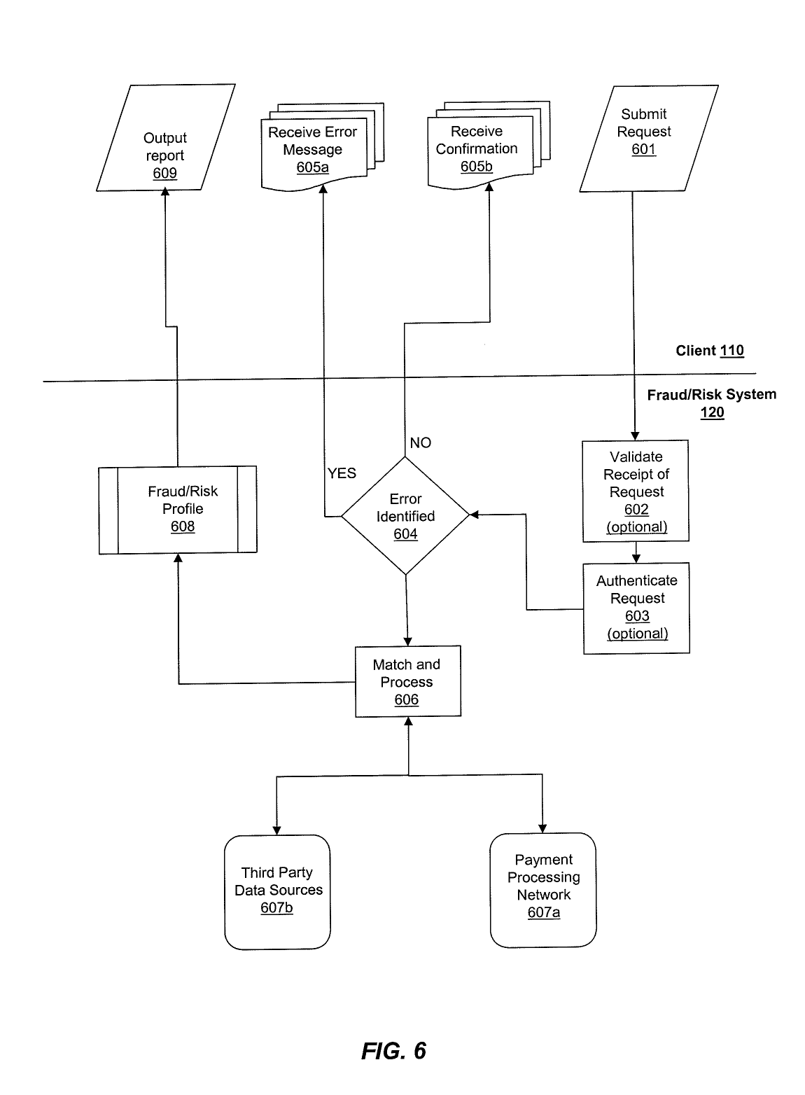

Having described some of the exemplary embodiments of the invention, the method of receiving a request from a user of the fraud/risk system 120 and providing a report to that user will now be described in detail. FIG. 6 shows a flowchart that illustrates the steps involved in processing a request and providing a report to the user. These steps will be described with reference to the elements of FIG. 1.

First, the user 110 submits a request using the client computer 112. The request may contain any one of name, address, social security number, and phone number associated with a person or any combination thereof (step 601). As an optional step, the fraud/risk system 120 validates the request to determine if the request contains the necessary information (step 602). As another optional step, the fraud/risk system 120 authenticates the request to determine if it comes from an authorized source (step 603). Next, it is determined whether there are any problems with the request (step 604) (i.e. request is from an unknown user, not enough data were provided, etc.). If there is any problem with the request, fraud/risk server computer 122 notifies the client computer 112 via an error message (step 605a).

In some embodiments, fraud/risk server computer 122 determines whether the request complies with a set of pre-defined standards. The pre-defined standards may include certain types of information associated with the consumer, information regarding the type of inquiry (i.e. whether the consumer is attempting to apply for a loan and for what amount), etc. If there are no error messages, the fraud/risk server computer 122 generates a confirmation that is provided to the client computer 112 (step 605b). Also, the request is provided to the match and process module 124 (step 606).

The match and process module then uses the data provided by the payment processing network (step 607a) and third party data sources (step 607b) to determine if there are any matches between any of the information that were provided in the request and the pre-filtered data accessible by the fraud/risk system 120. The match and process module 124 will then generate a fraud/risk report that will include the pre-filtered data that were found and additional data that may be the result of performing a process on the pre-filtered data. The process may include employing an algorithm to determine the probability of fraud/risk, and combing and cross-referencing different types of data to deduce additional results (step 608). The fraud/risk server computer 122 then provides the fraud/risk report to the client computer 112 (step 609).

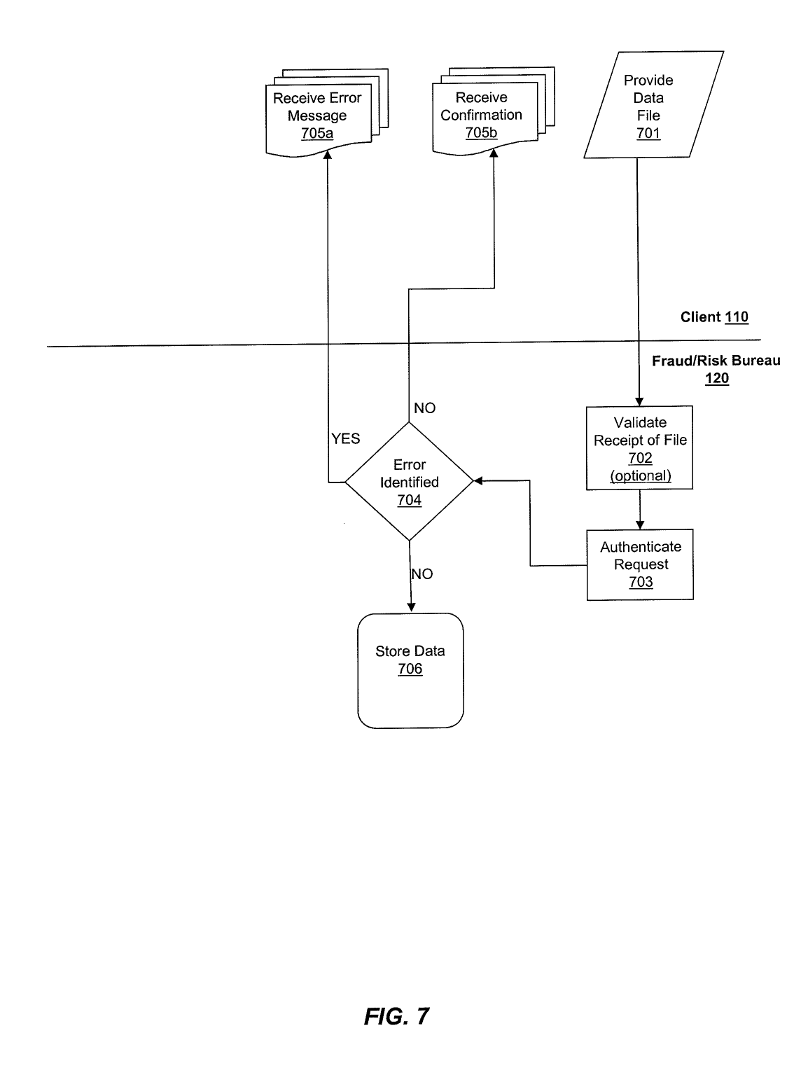

FIG. 7 shows a flowchart that illustrates the steps involved in receiving the pre-filtered data from the third party data sources and data from the payment processing network 130, according to an embodiment of the invention. First, the third party data sources or the payment processing network 130 provides a data file that includes the requested data to fraud/risk server computer 122 (step 701). The pre-filtered data can include an identifier such as name and/or social security number that associates the pre-filtered data with a person. As an optional step, the fraud/risk server computer 122 validates the receipt of the data file (step 702). The fraud/risk server computer 122 can also authenticates the entity that is requesting to provide data (step 703).

In some embodiments, the fraud/risk server computer 122 determines whether the request and/or the data complies with a set of pre-defined standards previously provided to the entities that provide pre-filtered data to the fraud/risk system 120 (step 704). If there are any problems with the request and/or the data, fraud/risk server computer 122 notifies the server computer of that entity via an error message (step 705a). Also, if there are no error messages, the fraud/risk server computer 122 generates a confirmation that is provided to the server computer of that entity (step 705b). If there are no error messages, the fraud/risk server computer 122 stores the received data in the fraud/risk database 126 (step 706).

In some embodiments, fraud/risk system 120 generates customized fraud/risk reports for users. The customization may be based on the request of the user 110 or based on pre-determined criteria stored in fraud/risk server computer 122. For example, the user 110 may request that additional types of information are provided with the data that provided in the fraud/risk report. These types of information may include degree of match between information provided by the client about a consumer (e.g., a confidence level of greater than 80% match), type of match (e.g. whether the consumer was previously involved with account fraud, identity fraud and/or application fraud), date of the incident, entity involved or the entity who reported such data, etc.

Embodiments of the invention provide several advantages. First, aggregating pre-filtered fraud data from third party sources, along with payment card transaction data, provides for an efficient fraud report system that allows for the efficient retrieval of fraud information while minimizing data storage requirements by storing such information at a central location. Also, it is more efficient to query a database that includes known relevant data (i.e. pre-filetered data) to locate the desired information. Second, combining data provided by a payment processing network and pre-filtered data provided by third party data sources allows for a more accurate fraud/risk report. Third, users of the fraud/risk system are able to request for customization of reports in a way that suits their particular need and without having to make business decision from a generalized report. Fourth, collaboration with third party data sources to report attempts of identity fraud benefits both the consumers and businesses by allowing them to safeguard against potential fraudulent activity before the incurring any loss.

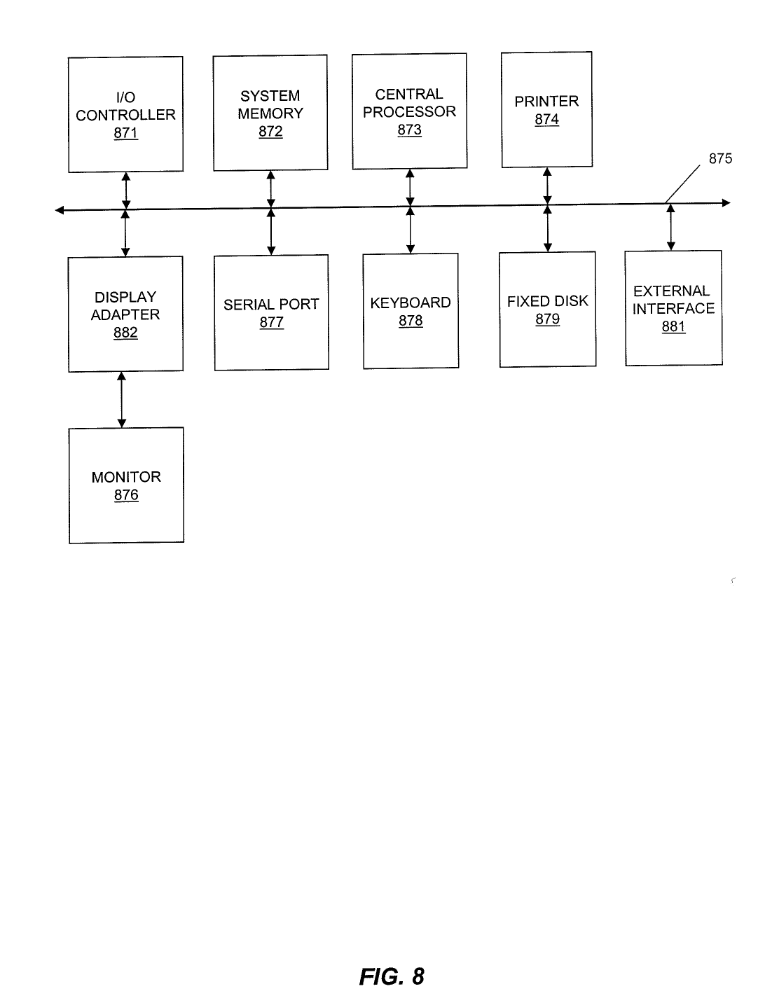

The various participants and elements in the previously described system diagrams (in FIGS. 1, and 2) may use any suitable number of subsystems to facilitate the functions described herein. Examples of such subsystems or components are shown in FIG. 8. The subsystems shown in FIG. 8 are interconnected via a system bus 875. Additional subsystems such as a printer 874, keyboard 878, fixed disk 879 (or other memory comprising computer-readable media), monitor 876, which is coupled to display adapter 882, and others are shown. Peripherals and input/output (I/O) devices, which couple to I/O controller 871, can be connected to the computer system by any number of means known in the art, such as serial port 877. For example, serial port 877 or external interface 881 can be used to connect the computer apparatus to a wide area network such as the Internet, a mouse input device, or a scanner. The interconnection via system bus allows the central processor 873 to communicate with each subsystem and to control the execution of instructions from system memory 872 or the fixed disk 879, as well as the exchange of information between subsystems. The system memory 872 and/or the fixed disk 879 may embody a computer-readable medium.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method comprising:
receiving a request for data associated with a consumer from a client computer at a server computer;
querying a database, using the server computer, for data associated with a consumer, wherein the database stores pre-filtered data associated with reported fraudulent activities, and wherein the pre-filtered data are provided from a plurality of data sources and a payment processing network; and
generating a report including the information retrieved from the database, using the server computer.

2. The method of claim 1, further comprising:
validating receipt of the request for data;
authenticating the request;
determining whether the request complies with a set of pre-defined standards; and
providing the report to the client computer.

3. The method of claim 1, wherein the report is a fraud report that indicates whether the consumer is a target of identity fraud.

4. The method claim 1, wherein the report is a risk report that indicates a probability that the consumer may defraud a business entity.

5. The method of claim 1, wherein the plurality of data sources includes a bank.

6. The method of claim 1, wherein the plurality of data sources includes a credit bureau.

7. The method of claim 1, wherein the payment processing network communicates with an acquirer and an issuer to facilitate a payment transaction.

8. The method of claim 1, wherein the report is a customized report.

9. The method of claim 8, wherein the report is customized based on a request from a user operating the client computer.

10. The method of claim 8, wherein the customized report includes a degree of match, date of an incident, entity involved, and the data source that reported the pre-filtered data.

11. A system comprising:
a server computer having a processor and a computer readable medium, wherein the computer readable medium stores code executable by the processor, for implementing a method comprising:
receiving a request for data associated with a consumer from a client computer at a server computer;
querying a database, using the server computer, for data associated with a consumer, wherein the database stores pre-filtered data associated with reported fraudulent activities, and wherein the pre-filtered data are provided from a plurality of data sources and a payment processing network; and
generating a report including the information retrieved from the database, using the server computer.

12. The system of claim 11, wherein the method further comprises:
validating receipt of the request for data;
authenticating the request;
determining whether the request complies with a set of pre-defined standards; and
providing the report to the client computer.

13. The system of claim 11, wherein the report is a fraud report that indicates whether the consumer is a target of identity fraud.

14. The system of claim 11, wherein the report is a risk report that indicates the probability that the consumer may defraud a business entity.

15. The system of claim 11, wherein the report is a customized report.

16. The system of claim 11, wherein the report is customized based on a request from user.

17. The system of claim 11, wherein the customized report includes a degree of match, date of an incident, entity involved, and the data source that reported the pre-filtered data.

18. A method comprising:
submitting a request to a server computer using a client computer, wherein the request includes an identifier for a consumer; and
receiving a report from the server computer, wherein the report includes data derived from pre-filtered data from a plurality of data sources and data from a payment processing network.

19. The method of claim 18, wherein the identifier includes at least one of a name, address, social security number, and phone number, and wherein the method further comprises customizing the request by indicating the types of data to be placed in the report.

20. A computer readable medium comprising code, executable by a processor for performing the method of claim 19.

21. A server computer comprising the processor and the computer readable medium of claim 20 coupled to the processor.
